(19) United States
(12) Patent Application Publication
(10) Pub. No.: US 2004/0156133 A1
(43) Pub. Date: Aug. 12, 2004

(54) Removably attachable portable three-way mirror system and method for making the same

(76) Inventor: Robert D. Vernon, Boulder, CO (US)

Correspondence Address: Ronald C. Harris, Jr., 2830 S. Meade St., Arlington, VA, 22206, US

(21) Appl. No.: 10/762,987

(22) Filed: Jan. 22, 2004

Related U.S. Application Data
(60) Provisional application No. 60/446,839, filed on Feb. 12, 2003.

(51) Int. Cl. G02B 5/08

(52) U.S. Cl. 359/866; 359/871

(57) ABSTRACT

A mirror assembly that includes a detachable mirror; a hinge; and a removably attachable fastener; wherein the detachable mirror is operably mounted onto a second mirror with the attachable fastener and operably positioned at a non-parallel angle with respect to the second mirror. A method of creating a multi-angled, multi-paneled mirror system is also disclosed.

### FIELD OF THE INVENTION

The present invention relates to a portable mirror and a method for using the same. The present invention more particularly relates to a portable mirror assembly that can be mounted onto a stationary mirror to create a multi-angled, multi-panel mirror system, and a method for creating such system.

### BACKGROUND OF THE INVENTION

Personal grooming and cleaning is made easier when a person can inspect the sides of his or her face and head. It is useful during shaving and while applying make-up, for example, to see the sides of one's face, neck, and hair. One way to do this is by using a stationary, three-way mirror.

Because the desire for the benefits of a three-way mirror still exists when traveling, at least two patents disclose portable three-way mirrors for use away from home. U.S. Pat. No. 393,679 discloses a “Portable Toilet Case and Triplicate Mirror,” and U.S. Pat. No. 1,381,874 discloses a “Traveling Suite,” both of which provide portable three-way mirrors. Yet, these devices are both bulky and heavy, especially given the size of the mirrors they provide.

More recent attempts to enhance our ability to groom while traveling have included somewhat more effective devices that are mounted with a suction device. U.S. Pat. No. 5,623,955 discloses “Shaving Equipment” that includes a mirror that is wall-mounted with a suction cup, but it fails to provide a multi-angled mirror system. U.S. Pat. No. 4,611,716 discloses a “Closable Hanging Vessel and Method of Use” that can be wall-mounted with suction cups, but it likewise fails to provide a multi-angled mirror system.

U.S. Pat. No. 5,416,635 discloses a “Portable Condensation-Free Shower Mirror” that can be mounted onto a stationary mirror, but it also fails to provide a multi-angled mirror system.

Hence, the prior art fails to provide a portable mirror assembly that provides a multi-angled mirror system.

### SUMMARY OF THE INVENTION

Thus, the present invention is directed to a detachable, portable mirror that, when combined with a pre-existing mirror, forms a system of at least two, separate and distinctly angled, mirrors for personal grooming.

The present invention is also directed to a portable mirror that can be interchangeably used as either a right-side or a left-side panel in a multi-angled mirror system.

The present invention is also directed to a method for creating a portable three-way mirror system.

One aspect of the present invention is directed to a detachable mirror that is operably combined with a second mirror with a removably attachable fastener and operably positioned at a non-parallel angle with respect to the second mirror; wherein the detachable mirror, when combined with the second mirror and positioned at the non-parallel angle, creates a multi-panel, multi-angled mirror system.

In another aspect, the system is created from at least two, separate and distinctly angled, mirrors.

In yet another aspect, the second mirror is a stationary mirror.

In still another aspect, the detachable mirror can be adjustably positioned at many non-parallel angles with respect to the second mirror with a hinge.

In yet another aspect, the hinge comprises a living hinge, a continuous hinge, or a pin hinge.

In still another aspect, the hinge has two leafs, the first leaf being permanently affixed to the detachable mirror and the second leaf being permanently affixed to the removably attachable fastener.

In yet another aspect, the attachable fastener comprises a clip, a hanger, a removable adhesive, or a suction cup.

In still another aspect, the attachable fastener comprises a clip, a hanger, a removable adhesive, or a suction cup.

In yet another aspect, the detachable mirror is portable.

In still another aspect, the detachable mirror is made of a lightweight material.

In yet another aspect, the detachable mirror comprises plastic.

In still another aspect, the detachable mirror comprises acrylic, polypropylene, polyethylene, polystyrene, or polycarbonate.

In yet another aspect, the detachable mirror operates as a side panel in a three-panel system, and is rotatably interchangeable with an opposite-side panel in the three-panel system.

In still another aspect, the second mirror is a non-stationary mirror.

In yet another aspect, the removably attachable fastener comprises a suction cup.

In still another aspect, the detachable mirror maintains its position with respect to the second mirror.

In yet another aspect, the detachable mirror has a hinge indexing device.

In still another aspect, the hinge indexing device comprises a spur gear.

Another aspect of the invention is directed to a mirror panel assembly, comprising a detachable mirror; a rotation enabling device; and a removably attachable fastener; wherein the detachable mirror is operably mounted onto a face of a second mirror with the removably attachable fastener and operably positioned at a non-parallel angle with respect to the face of the second mirror.

In another aspect, the detachable mirror, when attached to the second mirror and positioned at the non-parallel angle, creates a multi-panel, multi-angled mirror system.

In still another aspect, the rotation enabling device comprises a living hinge, a continuous hinge, or a pin hinge, and the removably attachable fastener comprises a clip, a clamp, a hanger, a bracket, a magnet, a removable adhesive, or a suction cup.

Another aspect of the invention is directed to a method of creating a portable three-way mirror system, comprising securing a rotation enabling device to a portable light-weight mirror; and securing at least one removably attachable fastener to the mirror; wherein the mirror is operably combined with a pre-existing mirror to form a system of a t least two, separate and distinctly angled, mirrors.

In another aspect, the method comprises the steps of removably attaching the at least one removably attachable fastener to a pre-existing mirror; and adjusting an angle between the portable mirror and the stationary mirror to create a multi-angled effect.

In still another aspect, one portable mirror is placed towards a left side of the stationary mirror and a second portable mirror is placed towards a right side of the stationary mirror.

In yet another aspect, the rotation enabling device comprises a living hinge or a continuous hinge.

In still another aspect, the removably attachable fastener comprises a clip, a hanger, a removable adhesive, or a suction cup.

### BRIEF DESCRIPTION OF THE DRAWINGS

In the accompanying drawings, which form a part of the specification and are to be read in conjunction therewith, and in which like reference numerals are used to indicate like parts in the various views:

FIG. 1 is a front view of a three-way mirror system, according to the present invention;

FIG. 2 is a top view of a person standing in front of the three-way mirror system in FIG. 1;

FIG. 3 is a rear view of the right-side mirror panel assembly in FIG. 1, which has suction cups attached to one leaf of a “living” hinge, according to the present invention;

FIG. 4 is a cross-sectional, top, cut-away view of the right-side mirror panel assembly in FIG. 3, along line Y—Y;

FIG. 4a is a side view of the “living” hinge in FIGS. 3 and 4;

FIG. 5 is a plan view of a continuous hinge, according to the present invention;

FIG. 6 is a cross-sectional view of the continuous hinge in FIG. 5, along line X—X;

FIG. 7 is a cut-away, plan view of the continuous hinge in FIG. 5, that has a screw mounting and a hinge indexing device, according to the present invention;

FIG. 8a is a cut-away, perspective, rear view of a mirror panel assembly that is being mounted onto a stationary mirror with a spring-loaded clip, according to the present invention;

FIG. 8b is a cut-away, perspective, rear view of a mirror panel assembly that is being mounted onto a stationary mirror with a hanger, according to the present invention; and

FIG. 8c is a cut-away, perspective, rear view of a mirror panel assembly that is mounted onto a stationary mirror with a removable adhesive, according to the present invention.

### DETAILED DESCRIPTION OF THE INVENTION

As illustrated in the accompanying drawings and discussed in detail below, one aspect of the present invention is directed to a detachable mirror panel assembly that, when used, is mounted onto the front face of a flat stationary mirror with a removably attachable fastener. The detachable mirror is positioned at an angle different from, i.e., not parallel to, the stationary mirror. Thus, when attached to the stationary mirror and positioned at a desired non-parallel angle, the detachable mirror creates a multi-panel, and distinctly multi-angled, mirror system.

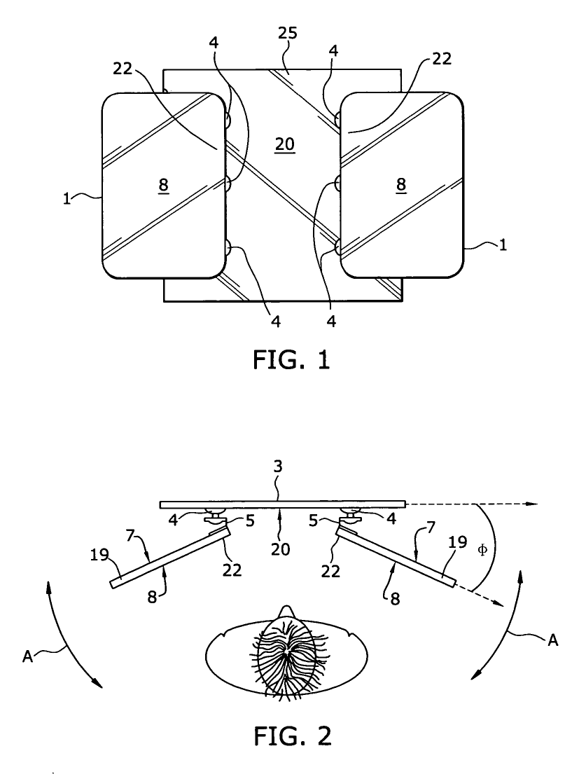

In one embodiment, the mirror assembly of the present invention defines a capacity generically called a “three-way mirror system.” This allows a stationary mirror to become a three-way mirror. Referring to FIGS. 1 and 2, stationary mirror 20 is permanently and vertically, or nearly vertically, mounted at its back side 3. Assemblies 1 are vertically, or nearly vertically, mounted onto stationary mirror 20. Thus, when two portable mirror assemblies 1 are attached to stationary mirror 20, one acts as a right-hand panel and the other acts as a left-hand panel, to create the effect of a three-way mirror.

Referring to FIG. 2, portable mirror panel assemblies 1 include a pair of lightweight, removable and break-resistant mirrors 8; hinges 5; and suction cups 4. Mirrors 8 each have reverse (back) sides 7, and respective vertical side edges 19 and 22. According to a user's desire, each of mirrors 8 can be angularly positioned, for example at angle φ, with respect to stationary mirror 20. For each mirror assembly 1, a user can grab outside edge 19, and independently position mirror 8 to his or her liking. Thus, hinges 5 can be independently opened and closed, and each of mirrors 8 independently swings back and forth, as indicated by direction arrows A.

Mirror assemblies 1 are identical to one another and individually symmetrical about a horizontal axis when mounted. As a result, they are interchangeable. What is more, each assembly 1 can be used as both a right-hand panel or as a left-hand panel. This dual capability is accomplished simply by converting assembly 1 from use on one side of mirror 20 to the other side, which requires only rotating it 180° about a line normal to the front face of mirror 8, and shifting it into position.

Mirrors 8 are made from a plastic material. Suitable plastic materials include, but are not limited to, acrylic, polypropylene, polyethylene, polystyrene, polycarbonate, and any combinations or co-polymers thereof. However, any lightweight synthetic or natural materials suitable for being detachably mounted onto a vertically disposed second mirror can be used to form mirrors 8. Suitable mirrors can comprise, moreover, any reflective surface material applied to one or more of these materials, e.g., when these materials are used primarily as a backing for mirror 8.

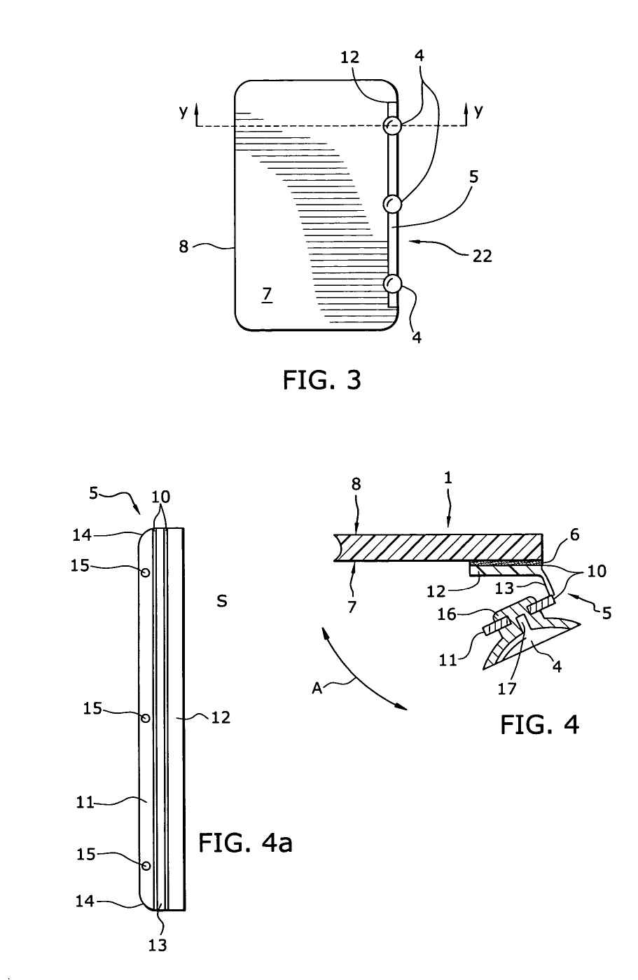

Referring to FIG. 3, each mirror 8 has a “living” hinge 5 secured to its vertical edge 22, which allows adjustment of mirror 8's position, and thus, its angle of reflection φ with respect to stationary mirror 20. “Living” hinges useful for this invention can be formed from any material that is suitable for extensive bending such as polypropylene.

As more particularly seen in FIG. 4, one leaf 12 of “living” hinge 5 is attached to reverse side 7 of mirror 8 with high strength, pressure sensitive adhesive 6, which is obtainable from Minnesota Mining and Manufacturing, Inc. of Minneapolis, Minn. Suitable adhesives for attaching mirror 8 to hinge 5 include, but are not limited to, super glue, wood glue, epoxy, and other bonding resins, depending on the composition of the mirror and hinge. Any device or method suitable for securing mirror 8 to hinge 5 can be used alternately, such as for example, but not limited to, a screw, a key block, or a binding.

Suction cups 4 are permanently affixed to opposite leaf 11 of hinge 5, to enable removable attachment to stationary mirror 20. In particular, hinge 5 is attached at apertures 15 in leaf 11 (shown in FIG. 4a) to suction cups 4 by feeding end portions 16 of unitary cups 4 through apertures 15 in leaf 11. When each of cups 4 are compressed at their base, space 17 collapses, which allows concentrically wider end portions 16 to pass through apertures 15 similar to a conventional fastener passing through a grommet. In an alternate embodiment, cups 4 have two or more pieces, including a body and an elastomeric snap-on cap. Other mechanical and adhesive fasteners suitable for attaching cups 4 to hinge 5 may also be used. Midportion 13 of hinge 5 provides space for end portion 16 when mirror 8 is only slightly angled or when assembly 1 is not in use.

Referring to FIG. 4a, rounded corners 14 allow for comfortable and easy attachment and removal of suction cups 4. Flexible hinge fold lines 10 create a compound hinge that increases the range of controlled and maintained angular positioning. In an alternate embodiment, more than two fold lines, or various types of living hinge fold lines, can be used as well. Thus, when mounted onto the front face of stationary mirror 20, mirror 8 can swing about an axis defined by the intersection of leafs 11 and 12, as indicated by direction arrow A in FIG. 4.

Suction cups 4 are made from polyvinylchloride and are obtainable from Presto Galaxy Suction Cups, Inc. of New Hyde Park, N.Y. Any synthetic or natural elastomeric material suitable for forming removable suction cups can be used, however.

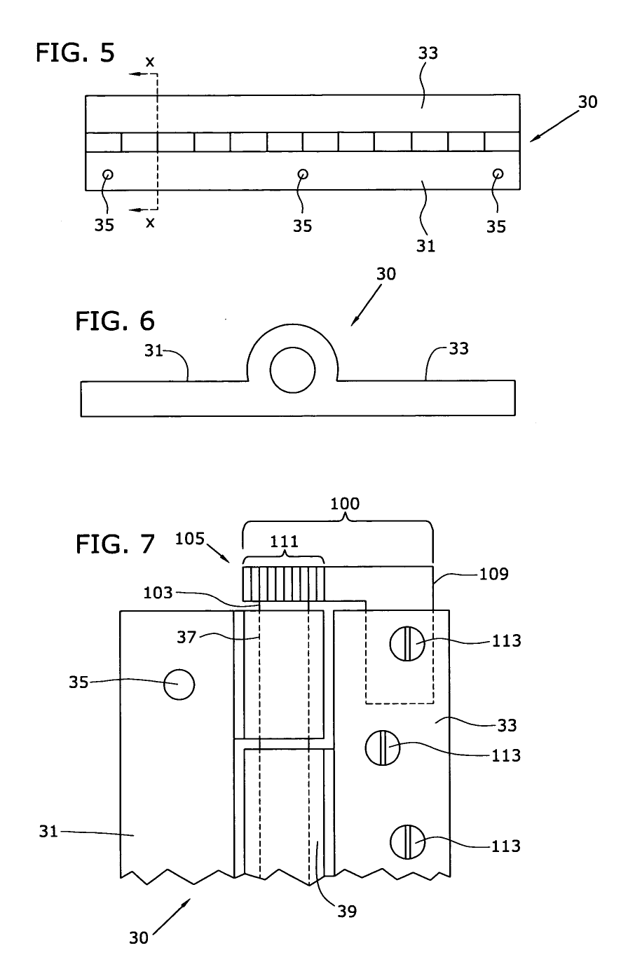

Referring to FIGS. 5 and 6, in an alternate embodiment, a continuous (also known as a piano-type) hinge 30, is used in place of “living” hinge 5. Suction cups 4 are attached to leaf 31 at apertures 35, and mirror 8 is adhered or attached to leaf 33 with a suitable attachable fastener. In one embodiment, hinge 30 is made from acrylic. Other hinges suitable for use with the present invention include, for example, pin hinges. Any rotation enabling device suitable for allowing angular adjustment between two mirrors can be used, however.

Referring to FIG. 7, continuous hinge 30 indexes to retain its position by using hinge indexing device 100. Hinge indexing device (HID) 100 permits a user to position hinge leaf 33 at any position along its range of rotation with respect to opposing hinge leaf 31. Shaft 103 of spur gear 105 is inserted into hinge pin slot 37, displacing in part, or in whole, hinge pin 38 (not shown). The diameters of shaft 103 and gear 105 are approximately equal to the diameters of respective pin slot 37 and hinge shaft 39. Spur gear 105 is attached to hinge leaf 31 by an adhesive so that its rotational movement coincides with the relative rotation of leaf 31.

Flat member 109, which is fastened at one end to opposing hinge leaf 33 and made of spring steel, rests between two of gear teeth 111. It thereby maintains a user's desired angular position of mirror panel 8 until the user alternately positions mirror 8. When resting between any two of gear teeth 111, flat member 109 provides sufficient resistance against the angular movement of mirror 8 to maintain a desired angular positioning of mirror 8 until it is alternately positioned by the user. When so positioned, movement of hinge leaf 33 causes flat member 109 to flex until it clears one of teeth 111 and snaps back to occupy the next available space between teeth 111. By adjusting the teeth size, number, and materials, as well as the material and thickness of flat member 109, HID 100 maintains the position of hinge leaf 33 with varying resistance, for mirror panels of varying sizes and weights.

Flat member 109 is attached to leaf 33 by securing flat member 109 between leaf 33 and mirror panel 8 with one of screws 113. Any fastener suitable for attaching flat member to leaf 33 can be used, however, including but not limited to, adhesives and other fasteners. Alternately, flat member 109 can be attached to leaf 31 and spur gear 105 can be attached to leaf 33.

Numerous other types of hinge indexing devices and position retention devices are also suitable for the present invention, however.

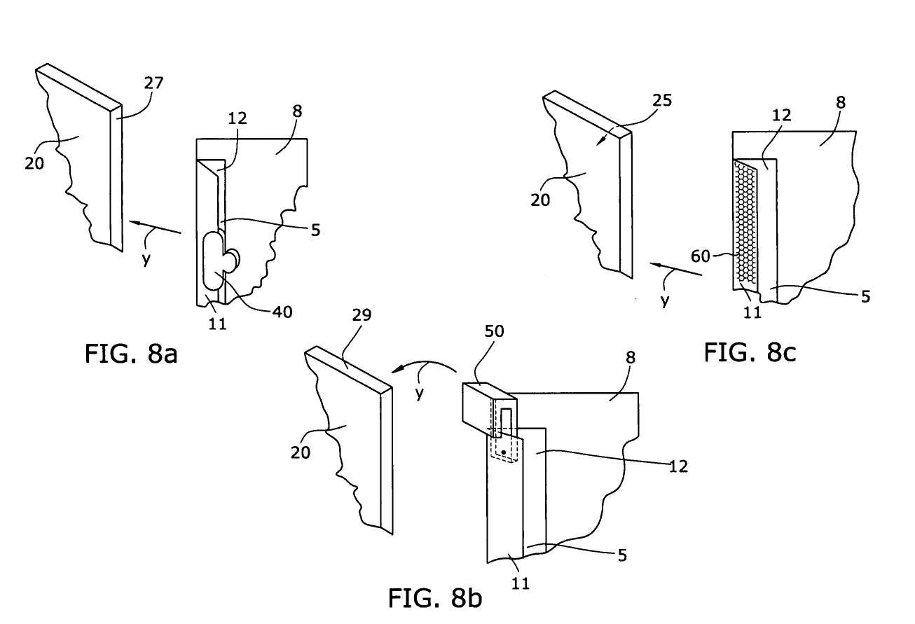

Referring to FIGS. 8a-c, in three alternate embodiments, suction cups 4 are replaced by a clip or clamp (e.g., at the side of mirror 20), a hanger or hanging bracket (e.g., from the top of mirror 20), or a removable adhesive. Referring to FIG. 8a, leaf 11 is attached to side edge 27 of stationary mirror 20 by spring-loaded clip 40. Referring to FIG. 8b, leaf 11 is attached to top edge 29 of stationary mirror 20 by hanger 50. Referring to FIG. 8c, leaf 11 is attached to front face 25 of stationary mirror 20 by removable, re-applicable adhesive 60. Other removably attachable fasteners suitable for attaching mirror assembly 1 to stationary mirror 20 can be used as well. As used herein, the term “removably attachable fastener” includes, but is not limited to, clips, clamps, hangers, removable adhesives, magnets, and suction cups.

In an alternative embodiment, only one mirror assembly 1 is used, which creates a two-way mirror system.

In another alternate embodiment, mirror 8 is mounted onto a non-stationary mirror.

In one embodiment, the mirror panel assembly of the present invention is mounted onto a full-length mirror that itself is mounted onto a door, at health club or other public or private dressing room. The mirror panel assembly of the present invention can be virtually any size—extending the length of, or just a portion of—a pre-existing mirror.

In one embodiment, mirror 8 is equipped with a non-fogging mirror panel assembly that is heated by an electrical current, as is disclosed, for example, in U.S. Pat. No. 5,731,569, which is hereby incorporated by reference in its entirety.

In an alternate embodiment, mirror 8 is equipped with a non-fogging mirror panel assembly that is heated by a pre-warmed fluid, as is disclosed, for example, in U.S. Pat. No. 5,416,635, which is hereby incorporated by reference in its entirety.

Thus, the portable mirrors of this invention are ideal for travel. They could also be used in the home and left permanently affixed to a bathroom mirror if so desired.

A second aspect of the invention is directed to a method of creating a portable three-way mirror system. Referring again to FIGS. 3 and 4, this method includes securing leaf 12 of hinge 5 (or other rotation enabling device) onto vertical edge 22 of each portable lightweight mirror 8, and securing at least one suction cup 4 (or other removably attachable fasteners) to opposite leaf 11 of hinge 5 (or other rotation enabling device). Referring again to FIG. 2, the method also includes attaching vertically oriented suction cups 4 (or other removably attachable fasteners) of each portable mirror 8 to a stationary mirror 20 with one such portable mirror to the user's left and the other to the user's right, thus removably affixing portable mirrors 8 to stationary mirror 20. The method also includes adjusting the angle of reflection φ of the portable mirrors 8 as desired in relation to one another and the portion of stationary mirror 20 between portable mirrors 8, to create a three-way effect.

Several, suitable rotation enabling devices, removably attachable fasteners, position retention devices and other variations of this method are described above. Other suitable variations can be used with this invention, however.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments that would come within the spirit and scope of the present invention.

I claim:

1. A mirror, comprising:
a detachable mirror that is operably combined with a second mirror with a removably attachable fastener and operably positioned at a non-parallel angle with respect to the second mirror;
wherein the detachable mirror, when combined with the second mirror and positioned at the non-parallel angle, creates a multi-panel, multi-angled mirror system.

2. The mirror of claim 1 wherein the system is created from at least two, separate and distinctly angled, mirrors.

3. The mirror of claim 1 wherein the second mirror is a stationary mirror.

4. The mirror according to claim 1 wherein the detachable mirror can be adjustably positioned at many non-parallel angles with respect to the second mirror with a hinge.

5. The mirror of claim 4 wherein the hinge comprises a living hinge, a continuous hinge, or a pin hinge.

6. The mirror of claim 4 wherein the hinge has two leafs, the first leaf being permanently affixed to the detachable mirror and the second leaf being permanently affixed to the removably attachable fastener.

7. The mirror of claim 6 wherein the attachable fastener comprises a clip, a hanger, a removable adhesive, or a suction cup.

8. The mirror of claim 1 wherein the attachable fastener comprises a clip, a hanger, a removable adhesive, or a suction cup.

9. The mirror of claim 1 wherein the detachable mirror is portable.

10. The mirror of claim 9 wherein the detachable mirror is made of a lightweight material.

11. The mirror of claim 9 wherein the detachable mirror comprises plastic.

12. The mirror of claim 11 wherein the detachable mirror comprises acrylic, polypropylene, polyethylene, polystyrene, or polycarbonate.

13. The mirror of claim 1 wherein the detachable mirror operates as a side panel in a three-panel system, and is rotatably interchangeable with an opposite-side panel in the three-panel system.

14. The mirror of claim 1 wherein the second mirror is a non-stationary mirror.

15. The mirror of claim 1 wherein the removably attachable fastener comprises a suction cup.

16. The mirror of claim 1 wherein the detachable mirror maintains its position with respect to the second mirror.

17. The mirror of claim 16 wherein the detachable mirror has a hinge indexing device.

18. The mirror of claim 17 wherein the hinge indexing device comprises a spur gear.

19. A mirror panel assembly, comprising:
a detachable mirror;
a rotation enabling device; and
a removably attachable fastener;
wherein the detachable mirror is operably mounted onto a face of a second mirror with the removably attachable fastener and operably positioned at a non-parallel angle with respect to the face of the second mirror.

20. The mirror panel assembly of claim 19 wherein the detachable mirror, when combined with the second mirror and positioned at the non-parallel angle, creates a multi-panel, multi-angled mirror system.

21. The mirror panel assembly of claim 19 wherein the rotation enabling device comprises a living hinge, a continuous hinge, or a pin hinge, and the removably attachable fastener comprises a clip, a clamp, a hanger, a bracket, a magnet, a removable adhesive, or a suction cup.

22. A method of creating a portable three-way mirror system, comprising:
securing a rotation enabling device to a portable light-weight mirror; and
securing at least one removably attachable fastener to the mirror;
wherein the mirror is operably combined with a pre-existing mirror to form a system of at least two, separate and distinctly angled, mirrors.

23. The method of claim 22 further comprising the steps of removably attaching the at least one removably attachable fastener to a pre-existing mirror; and
adjusting an angle between the portable mirror and the stationary mirror to create a multi-angled effect.

24. The method of claim 22 wherein one portable mirror is operably placed towards a left side of the pre-existing mirror and a second portable mirror is operably placed towards a right side of the pre-existing mirror.

25. The method of claim 22 wherein the rotation enabling device comprises a living hinge or a continuous hinge.

26. The method of claim 22 wherein the removably attachable fastener comprises a clip, a hanger, a removable adhesive, or a suction cup.
